(19) United States
(12) Patent Application Publication
(10) Pub. No.: US 2024/0154362 A1
(43) Pub. Date: May 9, 2024

(54) ELECTRICAL CONNECTOR ARRANGEMENT WITH MATE-ASSIST SLIDER

(71) Applicant: Aptiv Technologies AG, Schaffhausen (CH)

(72) Inventors: Ricardo J. GOMEZ, NÜrnberg (DE); Naveen Selvamani, Salem (IN); Uvaraj Ganesan, Chennai (IN)

(21) Appl. No.: 18/503,512

(22) Filed: Nov. 7, 2023

(30) Foreign Application Priority Data
Nov. 7, 2022 (EP) 22205841.4

(51) Int. Cl. H01R 13/629

(52) U.S. Cl. CPC H01R 13/62977; H01R 13/62944

(57) ABSTRACT

An electrical connector arrangement includes a connector housing and a mate-assist lever. The mate-assist lever is rotatable about a pivot point and is configured to facilitate, upon rotation, mating and unmating with a corresponding electrical counter-connector. The pivot point is configured to move relative to the connector housing upon rotation of the mate-assist lever.

### CROSS-REFERENCE TO RELATED APPLICATION

This application claims the benefit of and priority to European Patent Application No. 22205841.4, filed Nov. 7, 2022, the contents of which are incorporated by reference herein.

### TECHNICAL FIELD OF THE INVENTION

The present invention generally relates to an electrical connector arrangement. Particularly the present invention relates to an electrical connector arrangement including a mate-assist lever to facilitate mating and unmating of an electrical connector with a corresponding electrical counter-connector.

### BACKGROUND

In recent years a large range of new safety and comfort features were developed and introduced in the automotive sector, necessitating a connection to electronic control devices and the power supply of the vehicle. There is an increasing number of electrical and electronic devices that need to be connected, which results in a rapid increase of connector arrangements for the resulting large number of electrical signal lines. This increase of electrical contacts, which need to be mated, in turn, increase the forces necessary to close the connection between two complementary connector housings.

Some attempts have been made, particularly in the automotive industry, to address the issue of increasing mating forces. One example of a known implementation for such mating of electrical contacts is a lever-type electrical connector, which includes an assembly of a first (e.g., female) connector or housing and a second (e.g., male) connector. To mate the two connectors together, the assembly has an assisting lever mounted for pivoting about the first connector. Such pivoting of the lever causes the first and second connectors to move towards one another, thereby shifting between an unmated and a mated configuration. The first connector (and/or the actuating lever) and the second connector can have a mechanical arrangement (such as a cam groove and a cam follower arrangement). This mechanical arrangement serves the purpose of pulling the second connector into the mating configuration with the first connector in response to pivoting of the actuating lever. Such an example of a known electrical connector is commonly used but requires complex mechanics. Further still, large forces are necessary for mating.

Other known implementations of such lever-type electrical connectors include connectors, wherein the first connector has a housing, a cover, a U-shaped lever arm and a mate-assist slider. The mate-assist slider has a cam slot, which interacts with a corresponding cam peg of the second connector. Pivoting of the U-shaped lever arm about a fixed point of the first connector's housing provides for a horizontal movement of the mate-assist slider. This horizontal movement causes—by way of the mechanical interaction of the cam slot with the cam peg—the second connector to be pulled into the mating configuration with the first connector. The lever arm and/or the mate-assist slider serves as a mating aid for mating the two connectors. Furthermore, the lever arm surrounds the cover of the first connector during mating and unmating the first connector and the second connector.

However, these known implementations have several drawbacks. One drawback is that the mechanical arrangements are still complex and large forces for mating are required. This poses a problem in modern assembly lines, in which a quick and secure mating of the connectors has to be ensured. Furthermore, the known implementations are prone to increased frictional forces during mating and unmating the connectors, which makes the process difficult to perform. In addition, the operating space, such as the radius and length, of the lever is large. Thereby, the height of the cover of the first connector is increased to accommodate the length of the lever. Accordingly, the electrical connector is not compact, which is particularly disadvantageous in the automotive sector, which is characterized by harsh space restrictions.

A further drawback of the known implementations is that the fixed position of the pivot requires additional means such that that flexible mounting in any orientation of the electrical connector can be performed. As an example, a symmetrical assembly, which is particularly useful, cannot be performed easily with the known implementation. To the contrary, for such a symmetrical assembly, the position of the pivot point needs to be defined upfront according to the environment of application of the electrical connection. Thus, the field of application is severely limited. Further, automotive industry standards stipulate a maximum force of 75 N for the user required to perform mating and unmating of the connectors.

In view of the foregoing, there is a need to improve electrical connectors, as the known implementations fail to address the requirements of electrical connectors to a sufficient degree and offer room for improvement.

It is thus an object of the present invention to overcome some or all of the deficiencies of the prior art. In particular, it is an object of the invention to provide for an improved electrical connector arrangement with mate-assist lever for mating with an electrical counter-connector. The electrical connector arrangement should be flexible in its field of application, should be able to mate and unmate easily and reliably and should be compact in space.

### SUMMARY

The above-mentioned objects are at least partially achieved by the subject-matter of the independent claims. Preferred embodiments are subject of the dependent claims, and the skilled person finds hints for other suitable aspects of the present invention through the overall disclosure of the present application.

An aspect of the invention relates to an electrical connector arrangement, including a connector housing; and a mate-assist lever being rotatable about a pivot point and configured to facilitate, upon rotation, mating and unmating with a corresponding electrical counter-connector; wherein the pivot point is configured to move relative to the connector housing upon rotation of the lever.

In this manner, the present disclosure provides an electrical connector arrangement, which allows an improved mating and unmating with the electrical counter-connector, wherein the forces for mating can be substantially reduced. The electrical connector arrangement is also compact in space, as the installation height can be reduced. At the same time, the length of the mate-assist lever can be increased compared to known implementations. This promotes reducing of mating forces for the same torque required for rotating the mate-assist lever.

Furthermore, the electrical connector arrangement can be applied in various environments and field of applications. That is, because the pivot point can be easily arranged to be substantially symmetrical with respect to the connector housing, as it is movable upon rotation of the lever. This is advantageous compared to fixed pivot points. The compact size and the reduced force makes it particularly useful in engineering sectors, such as the automotive sector.

In a preferred embodiment of the electrical connector arrangement described herein, the arrangement is further including a mate-assist slider configured to be mounted linearly movable on the connector housing. The mate-assist slider has the advantage that it allows for simplified movement. The linear movement allows for a motion that can be easily controlled, adjusted and/or used to transfer movements to other parts. The term “configured” may be understood as the mate-assist slider is mounted linearly movable on the connector housing, but it should provide for means that allows the mate-assist slider to be mounted linearly movable on the connector housing.

In a preferred embodiment of the electrical connector arrangement described herein, the mate-assist lever is pivotably mountable on the mate-assist slider. This has the advantage that the lever can still be rotated (pivotably may also be understood as rotatable) when it is mounted on the slider. Furthermore, the pivot point of the lever may move with the slider. In one example, this embodiment may also be understood that the mate-assist lever can be rotationally hinged with the mate-assist slider. It is advantageous that the mate-assist slider is not mounted on the connector housing, as this would result in a fixed pivot point.

Preferably, the mate-assist slider, when mounted, is configured to be moved from a first position corresponding to an unmated condition of the connectors to a second position, corresponding to a mated condition. Typically, the first and the second position may be understood such that cam slot and cam follower arrangements are in a substantially start and a substantially end position. It may be feasible that several further intermediate position can be reached.

In one example, the first and second position of the mate-assist slider may be based on the extent of rotation of the mate-assist lever. Preferably, the mate-assist lever and the mate-assist slider are configured such that a rotation of the mate-assist lever causes a linear movement of the mate-assist slider relative to the connector housing. This has the advantage that the force required for mating can be reduced. The rotation of the mate-assist lever is translated into a respective linear movement. In one example, the linear movement may also be referred to as translational movement. Rotation of the lever may be easily performed, as it is convenient for a user and may not require extensive labor.

In one example, the rotation axis of the mate-assist lever is substantially perpendicular to the plane in which the mate-assist slider is moved.

In a preferred embodiment of the electrical connector arrangement described herein, the movement direction of the mate-assist slider is substantially perpendicular to the mating and unmating direction. This has the advantage that the mate-assist slider may be arranged in a compact fashion, as it may not interfere with the mating and unmating direction. This arrangement may also facilitate that, dependent on the design of the mate-assist slider (e.g., the design of cam slots), a small linear movement of the mate-assist slider may cause a relatively large translational movement of the electrical counter-connector, or vice versa, as desired.

Preferably, in one embodiment, the mate-assist slider does not include any functional toothed rack, a gear, and/or a pinion. The toothed rack, gear and/or pinion referred to in this embodiment are to be understood in a functional manner. The skilled person will recognize whether any such means provide for the function of acting as means that facilitate conversion/translation of movements (e.g., linear to linear, linear to rotational, or any combination thereof). The function of the toothed rack, a gear, and/or a pinion may also be fulfilled if the toothed rack, a gear, and/or a pinion is/are fixed and not movable/rotatable. It is appreciated that the mate-assist slide of the electrical connector arrangement according to this embodiment does not need such functional toothed rack, a gear, and/or a pinion. This is beneficial as any such means could otherwise impact the linear movement of the slider. For instance, these means could come in contact with the connector housing and hinder the movement of the mate-assist slider.

In a preferred embodiment of the electrical connector arrangement described herein, the connector housing includes a toothed rack and wherein the mate-assist lever includes a gear with one or more teeth, configured to mesh with the toothed rack upon rotation of the mate-assist lever. The meshing of the gear of the mate-assist lever with the toothed rack of the connector housing allows a translation of the rotational movement of the mate-assist lever to a corresponding linear movement of the mate-assist slider (and of the pivot point of the mate-assist lever as understood). Both parts (gear and toothed rack) are preferably provided in such a manner that they engage each other when the mate-assist lever is pivotably mounted on the mate-assist slider. Rotation of the mate-assist lever from a first mate-assist lever mounting position, into a second mate-assist lever position leads to a linear movement of the mate-assist slider along a guiding channel (as described herein elsewhere). The design of the gear and toothed rack may be altered (e.g., in size, diameter or the like) to influence and adapt the translation of rotation into linear movement as desired.

In a preferred embodiment of the electrical connector arrangement described herein, the toothed rack is arranged in a top portion of the connector housing, such that the teeth of the toothed rack are pointing in the unmating direction. This has the advantage that the teeth may not collect moisture, dirt and/or dust in the teeth, as any substances may substantially fall off from the teeth by way of gravity if the connector arrangement is in ordinary use. The embodiment may be understood in such a manner, that the gear may be configured to mesh with the toothed rack from the side of the connector housing at which the electrical counter-connector is configured to be received.

In one example, it may be possible to arrange the toothed rack in a bottom portion of the connector housing, e.g., in proximity to a portion at which the electrical counter-connector is configured to be received. In such an example, the teeth of the toothed rack are pointing in the mating direction. As understood, rotation of the mate-assist lever would then cause the mate-assist slider to move in the opposite linear direction compared to the prescribed embodiment.

In a preferred embodiment of the electrical connector arrangement described herein, the connector housing includes a flat guiding channel, formed by at least one outer wall of the connector housing, wherein the guiding channel is configured to receive the mate-assist slider, such that the mate-assist slider is configured to be at least partially enclosed by the connector housing. This has the advantage of improved guidance of the movement of the mate-assist slider during mating and unmating. The guiding channel ensures that the mate-assist slider is guided at least in part inside the connector housing, which prevents the mate-assist slider from being adversely affected by the environment. This is beneficial, as the environment could otherwise alter surface properties (e.g., a surface roughness) inside the guiding channel. Further, moisture, dirt and/or dust, could otherwise negatively impact a smooth mating procedure. Furthermore, external impacts could alter the position of the mate-assist slider. Thereby, the environment could impact the mating force, for the electrical contacts of the connector and the electrical counter-connector. In addition, a user performing mating and unmating may not interfere with the moving mate-assist slider as it is at least partially enclosed by the connector housing.

In a preferred embodiment of the electrical connector arrangement described herein, the flat guiding channel includes an opening in a substantially central position of the guiding channel and two side pockets on opposing ends of the guiding channel, the side pockets formed by an outer wall of the connector housing, wherein the opening facilitates receiving the mate-assist lever after the mate-assist slider is received in the guiding channel. The opening simplifies the assembly, as the mate-assist lever can be easily mounted to the mate-assist slider by guiding the lever along the opening. It may not be necessary to spread the arms, which could adversely impact the structural integrity of the lever. The central position promotes symmetry, such that mounting may be performed independent of an orientation of the connector housing. Furthermore, manufacturing of the opening may be improved. The side pockets further facilitate protection from environmental impacts.

In a preferred embodiment of the electrical connector arrangement described herein, the mate-assist slider has an at least partially circular recess and a circular sleeve in the center of the recess extending perpendicular from the recess for rotatably receiving the pivot point of the mate-assist lever. The at least partially circular recess may be understood in such a manner that the recess is formed by a circular segment, including an angle of at least 90°, 120°, 150°, 180° or more. The remaining angle (with respect to 360°) of the circular recess may be directed, when mounted, towards the top portion of the connector housing and/or towards the opening of the guiding channel. Thus, the pivot point and the gear of the mate-assist lever may be easily received by the opening and by the recess in the assembly process of the electrical connector. The mate-assist lever can thus be received at a defined position, namely by the circular sleeve. The pivot point of the mate-assist lever may enclose the sleeve when mounted and may be mounted coaxially to the extension direction of the sleeve. It is appreciated that the circular recess provides sufficient space such that the gear of the mate-assist lever can be easily rotated by rotating the mate-assist lever. Further the gear can easily mesh with the toothed rack of the connector housing. This may be further understood in that the recess provides for a gap in the perpendicular direction of the connector housing and the toothed rack may extend into that gap along the perpendicular direction. Further, also the gear of the mate-assist lever extends into that gap defined by the recess.

In a preferred embodiment of the electrical connector arrangement described herein, the mate-assist slider includes at least one cam slot configured to engage with at least one cam follower of the electrical counter-connector, such that a linear movement of the mate assist slider causes a relative movement of the connectors in mating respectively unmating direction. The cam follower (which may also be referred to as a cam peg) may be provided at an outer surface of the electrical counter-connector housing, for instance as an outer protrusion. The cam slots can be arranged so that the guidance of the cam followers in the cam slots during the translational movement of the mate-assist slider leads to a translational movement of the cam follower. Accordingly, when the mate-assist slider is moved perpendicularly to the mating direction, for instance horizontally, the cam follower and, thereby, the electrical counter-connector may move along mating direction (e.g., vertically). Thereby, mating of the electrical connectors is established. As an example, the cam slot could be arranged on a surface of the mate-assist slider that is facing the connector housing when mounted. The recess may be arranged on the opposite surface. This may ensure that the rotation and the meshing of the gear with the toothed rack of the connector housing does not interfere with the cam slot and a cam follower arrangement. Furthermore, this arrangement may facilitate that not foreign matter may be collected in the cam slot, which could hinder movement by increasing frictional forces.

In a preferred embodiment of the electrical connector arrangement described herein, the arrangement includes a mate-assist slider, and an electrical counter-connector including at least one cam follower; wherein the mate-assist slider is mounted linearly movable on the connector housing and includes at least one cam slot configured to engage with the at least one cam follower, wherein the connector housing includes a toothed rack, wherein the mate-assist lever is pivotably mounted on the mate-assist slider and includes a gear with one or more teeth configured to mesh with the toothed rack upon rotation of the mate-assist lever, wherein, upon rotation of the mate-assist lever, a linear movement of the mate-assist slider is caused, which causes a relative movement of the connectors in mating respectively unmating direction. This embodiment combines the advantages of the electrical connector arrangement described herein.

In one example, the mate-assist slider includes two oblique cam slots configured to engage with two cam followers of the electrical counter-connector, the connector housing includes a toothed rack with four teeth and the mate-assist lever includes a gear with three teeth configured to mesh with the toothed rack upon rotation of the mate-assist lever, and the electrical connector arrangement includes two mate-assist sliders movably mounted on two opposing sides of the connector housing in two flat guiding channels of the connector housing.

In a preferred embodiment of the electrical connector arrangement described herein, the arrangement is further including a cover configured to be mounted on a top side of the connector housing, opposite to a bottom side at which the electrical counter-connector is configured to be received, wherein the cover includes a cover latch that is configured to latch with the mate-assist lever, when the mate-assist lever is in a closed position in which the electrical connector is in a mating connection with the electrical counter-connector. The cover provides for a protection of, e.g., connector modules that are received in the connector housing. Further, the cover latch may serve as a security measure to maintain the electrical connectors securely mated. This may be particularly helpful in rough conditions, e.g., in automotive applications.

In one example, lever may be U-shaped and may at least partially encloses the connector housing and/or the cover of the electrical connector.

In a preferred embodiment of the electrical connector arrangement described herein, the arrangement further includes an electrical counter-connector; wherein the mate-assist lever and the mate-assist slider are mounted to the connector housing. The connector housing of the electrical connector arrangement described herein may include one or more, preferably five module slots for holding a corresponding number of connector modules.

In one example of the electrical connector arrangement, the maximum height of the electrical connector arrangement measured parallel to the mating and/or unmating direction is at most 78 mm, preferably at most 75 mm, more preferably at most 72 mm, more preferably at most 70.5 mm, most preferably at most 69.5 mm. Further, the maximum length of the mate-assist lever measured from the pivot point to an outermost point of the mate-assist lever along a radial direction may be at least 40 mm, preferably at least 50 mm, more preferably at least 55 mm, more preferably at least 58 mm, most preferably at least 60 mm. This has the advantage that the length of the lever is comparatively large compared to the height of the electrical connector. Thereby, the mate-assist lever force can be reduced whilst the electrical connector arrangement is compact in space.

In a further example, the mate-assist slider and/or the pivot point of the lever is configured to be moved linearly by an amount between 10 to 23 mm, preferably 12 to 21 mm, more preferably 14 to 19 mm, more preferably 16 to 17 mm, most preferably 16.2 to 16.6 mm between the mating and the unmating condition, such that the electrical counter-connector is configured to be moved perpendicularly (e.g. vertically) by an amount between 3 to 9 mm, preferably 4 to 8 mm, more preferably 5 to 6 mm, most preferably 5.7 to 5.9 mm between the mating and the unmating condition.

It is noted that the features, aspects, embodiments and/or advantages as described herein with reference to the electrical connector arrangement may likewise be applicable to the electrical connector, even if not expressly described as such but rather with reference to features, aspects, embodiments and/or advantages of the electrical connector arrangement.

### BRIEF DESCRIPTION OF THE DRAWINGS

The present invention is now described, by way of example with reference to the accompanying drawings, in which:

FIG. 1A illustrates an electrical connector in a mating connection with an electrical counter-connector according to the prior art, in a side view.

FIG. 1B illustrates the electrical connector according to the prior art of FIG. 1A in an unmating connection with an electrical counter-connector, in a side view.

FIGS. 1C and 1D illustrates the electrical connector according to the prior art of FIG. 1A, in a perspective view and in an exploded view.

FIG. 2A illustrates an electrical connector arrangement in a mating condition with an electrical counter-connector according to an embodiment of the invention, in a side view.

FIG. 2B illustrates FIG. 2A in an unmating connection with an electrical counter-connector, in a side view.

FIGS. 2C and 2D illustrates FIG. 2A in a perspective view and in an exploded view.

FIG. 3A illustrates FIG. 2A, with some parts being at least partially transparent.

FIG. 3B illustrates FIG. 2B, with some parts being at least partially transparent.

FIG. 4 illustrates a connector housing of an electrical connector arrangement according to an embodiment of the invention, in a side view.

FIG. 5 illustrates a mate-assist slider of an electrical connector arrangement according to an embodiment of the invention, in a side view.

FIGS. 6A to 6F illustrate an electrical connector arrangement according to an embodiment of the invention in different assembly steps, in a perspective view.

FIGS. 7A to 7C illustrate an electrical connector arrangement according to an embodiment of the invention in a mating process with an electrical counter-connector, in a perspective view.

FIGS. 8A to 8C illustrate FIGS. 7A to 7C, in a side-view, some parts being at least partially transparent.

FIG. 9 illustrates an electrical connector arrangement according to an embodiment of the invention with the teeth rack arranged in a top portion of the connector housing, in a side view.

FIG. 10 illustrates an electrical connector arrangement according to an embodiment of the invention with the teeth rack arranged in a bottom portion of the connector housing, in a side view.

FIGS. 11A to 11B illustrate an electrical connector arrangement in a mating process with an electrical counter-connector according to the prior art, in a side view.

FIGS. 12A to 12B illustrate an electrical connector arrangement according to an embodiment of the invention in a mating process with an electrical counter-connector, in a side view.

### DETAILED DESCRIPTION

In the subsequent passages, the invention is described with reference to the accompanying figures in more detail. It is noted that further embodiments are certainly possible, and the below explanations are provided by way of example only, without limitation. Throughout the drawings and description, the same reference numerals refer to the same elements. The figures may not be drawn to scale, and the relative size, proportions, and depiction of elements in the figures may be exaggerated for clarity, illustration, and convenience.

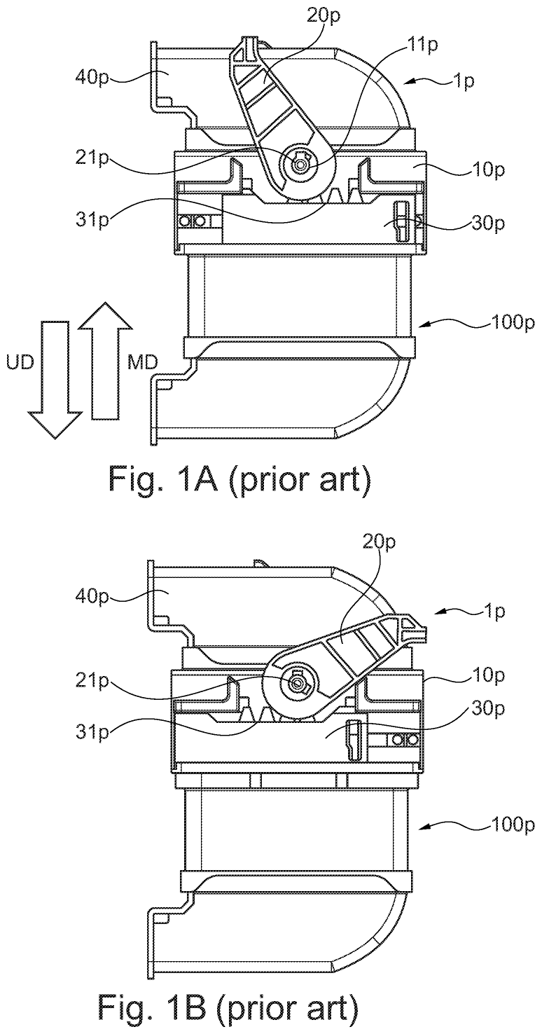

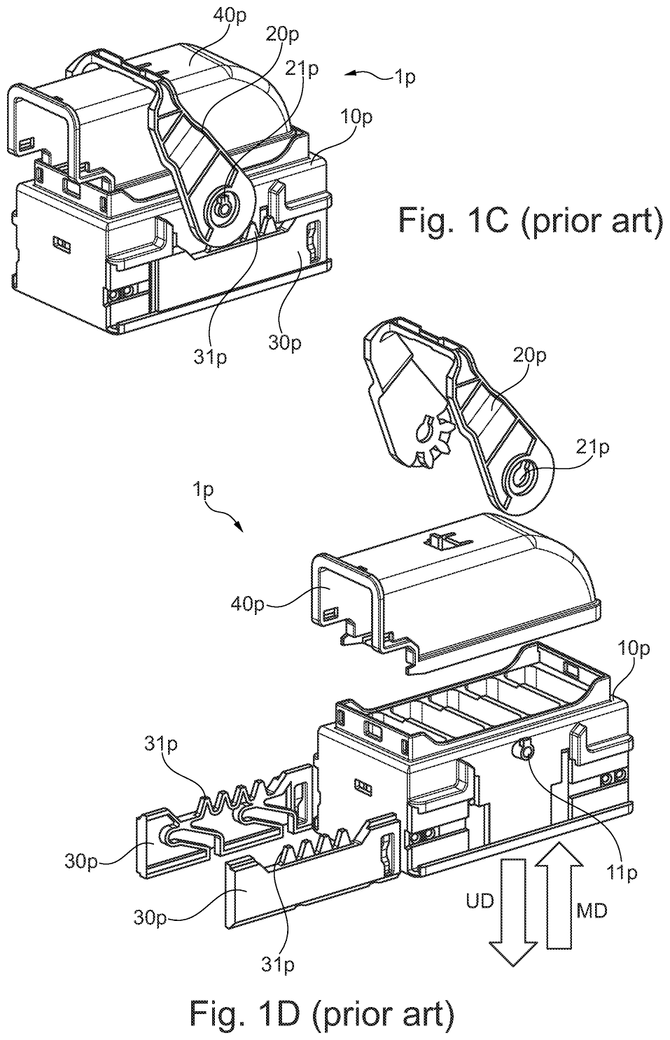

FIG. 1A shows an exemplary electrical connector arrangement 1p in a mating connection with an electrical counter-connector 100p according to the prior art in a mating connection. The electrical connector arrangement 1p includes a connector housing 10p, a lever 20p, two mate-assist sliders 30p (only the one on the front side is visible), and a cover 40p. The lever 20p has a pivot point 21p, about which the lever 20p is rotated. It can be seen that the connector housing 10p has a rotation pin 11p, which corresponds to the pivot point 21p. The rotation point of the lever 20p is therefore fixed to the connector housing 10p. The mate-assist slider 30p includes a toothed rack 31p, the teeth of the toothed rack 31p are pointing in the mating direction MD. The lever 20p further includes a gear that meshes with the toothed rack 31p. A rotation of the lever 20p causes the mate-assist slider 30p to move.

FIG. 1B shows the exemplary electrical connector arrangement 1p according to the prior art of FIG. 1A in an unmating condition with an electrical counter-connector 100p. Compared to FIG. 1A, the lever is rotated about the fixed pivot point 21p in an opening direction towards an opening position, such that the electrical connector arrangement 1p is in an unmating condition with the electrical counter-connector 100p. Rotation of the lever 20p caused the mate-assist slider 30p to move to the left side.

FIGS. 1C and 1D shows the exemplary electrical connector arrangement 1p according to the prior art of FIG. 1A and FIG. 1B, in a perspective view and in an exploded view. The two mate-assist sliders 30p include an inclined sliding mechanism, such that, upon movement of the mate-assist sliders 30p, the male connector, i.e., the electrical counter-connector 100p is also moved. The mate-assist sliders 30p are open to both sides of the connector housing 10p, i.e., there is no part of the connector housing 10p that covers the mate-assist sliders 30p. This arrangement has the disadvantage that the lever 20p has a fixed point of rotation. Such a fixed arrangement requires, for possible symmetrical mountings, the position of the rotation pin 11p to be clarified before the electrical connector arrangement 1p is used. Furthermore, the lever 20p operating space is larger causing the cover 40p height to be increased to accommodate to the increased lever 20p length. In addition, the length of the lever 20p arm is relatively low, which reduces leverage of the electrical connector arrangement 1p.

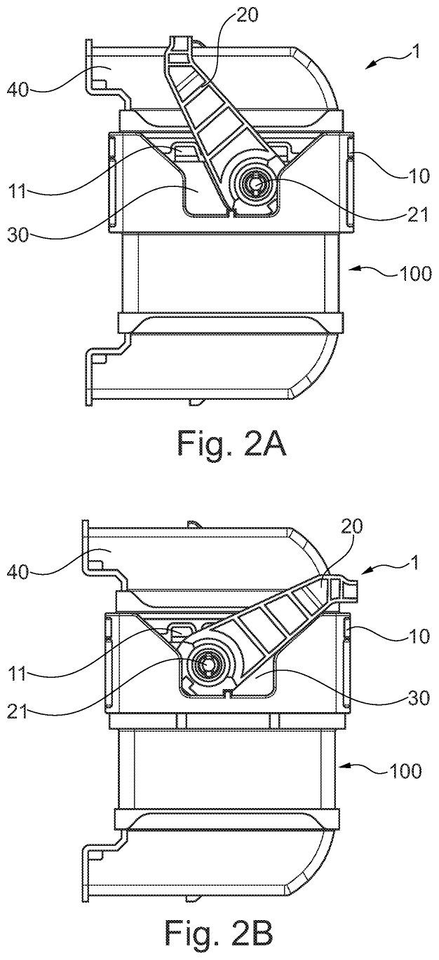

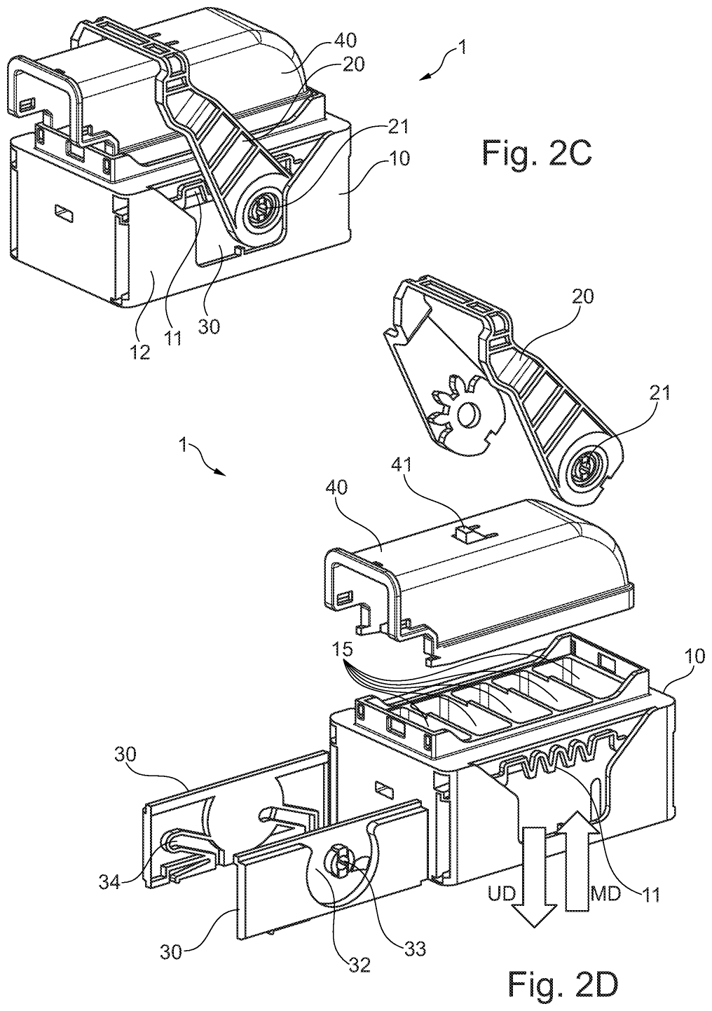

FIG. 2A shows an electrical connector arrangement 1 in a mating connection with an electrical counter-connector 100 according to an embodiment of the invention. The electrical connector arrangement 1 includes a connector housing 10 and a pivotable mate-assist lever 20 being rotatable about a pivot point 21 and configured to facilitate, upon rotation, the mating and unmating connection of the electrical connector arrangement 1 and an electrical counter-connector 100. The pivot point 21 is moved relatively to the connector housing 10 upon rotation of the lever 20.

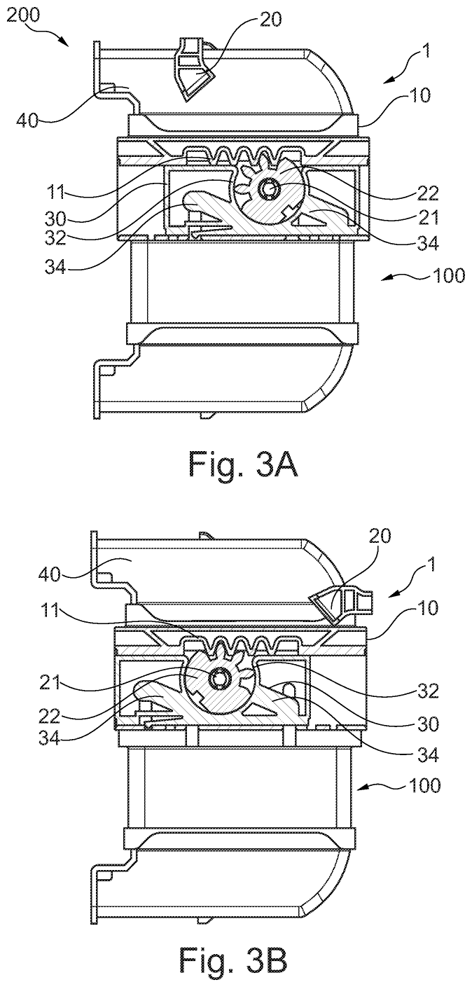

The electrical connector arrangement 1 can also include one or two mate-assist sliders 30 (only the one on the front side is visible) movably mounted on the connector housing 10 and configured to be in engagement with the electrical counter-connector 100. The mate-assist lever 20 is mounted on the mate-assist slider 30 and configured to be moved when the mate-assist slider 30 is moved. The electrical connector arrangement 1 further includes a cover 40. The connector housing 10 includes a toothed rack 11, the teeth of the toothed rack 11 are pointing in the unmating direction UD. The mate-assist lever 20 includes a gear 22 (FIG. 3) that meshes with the toothed rack 11. The mate-assist lever 20 and the mate-assist slider 30 are configured such that a rotation of the lever 20 causes a linear movement of the mate-assist slider 30 relative to the connector housing 10 and thereby a same translational movement of the pivot point 21.

FIG. 2B shows the electrical connector arrangement 1 according to the embodiment of FIG. 2A in an unmating connection with an electrical counter-connector 100. Compared to FIG. 2A, the lever 20 is rotated about the movable pivot point 21 in an opening direction towards an opening position, such that the electrical connector arrangement 1 is in an unmating condition with the electrical counter-connector 100. Rotation of the lever 20 caused the mate-assist slider 30 and the pivot point to move to the right side. As can be seen the electrical counter-connector 100 extends further at the bottom of the connector housing 10 of the electrical connector arrangement 1, which indicates the unmating connection.

FIGS. 2C and 2D shows the electrical connector according to the embodiment of FIG. 2A, in a perspective view and in an exploded view. The mate-assist sliders 30 (in this figure the two mate-assist sliders are shown 30) include one or more cam slots 34 having an inclined shape (e.g., angular guiding slots). The cam slots are configured to engage with at least one cam follower 110 (as best seen in FIG. 8C) of the electrical counter-connector 100. Accordingly, a horizontal movement of the mate-assist sliders 30 causes the electrical counter-connector 100 (which could be the male connector) to perform a vertical movement (e.g., in a perpendicular direction to the horizontal movement). In this figure, the cam lots 34 are inclined to the top left. Thus, a translational movement of the mate-assist slider 30 to the right side of this figure facilitates mating.

The mate-assist slider 30 includes an at least partially circular recess 32 (also shown in FIG. 5 in greater detail) for rotatably receiving the gear 22 of the lever 20. The mate-assist slider 30 includes a circular sleeve 33 in a central position of the at least partially circular recess 32 for rotatably fixing the pivot point 21 of the lever 20.

The connector housing 10 includes a flat guiding channel 12 extending in a direction substantially rectangular to the mating (MD) and unmating (UD) direction, wherein the mate-assist slider 30 is movably mounted in the flat guiding channel 12. Thereby, the mate-assist slider 30 is substantially enclosed and/or covered by the connector housing 10. The cover 40 is attached to a top side of the connector housing 10, opposite to a bottom side at which the electrical counter-connector 100 is configured to be received. The cover 40 includes a cover latch 41 that is configured to latch with the lever 20, when the lever 20 is in a lever closed position in which the electrical connector arrangement 1 is in mating connection with the electrical counter-connector 100. It can be seen that the lever 20 is generally U-shaped and has a generally horizontal crossbar and two substantially vertical sidebars. The sidebars extend substantially perpendicular from the ends of the crossbar towards the pivot point 21 of the lever 20.

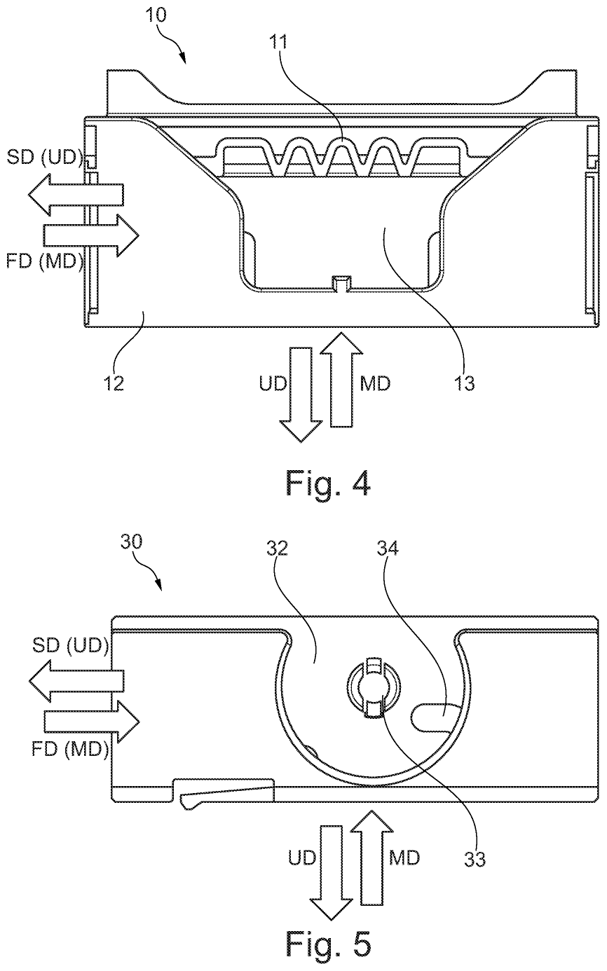

FIG. 3A shows FIG. 2A, where some parts are at least partially transparent. FIG. 3B shows FIG. 2B, where some parts are at least partially transparent. It can be seen that the mate-assist slider 30 is on the very right end of the connector housing 10 in the closed position of the lever 20 (mating connection) (FIG. 3). Thereby, the gear 22, which includes three teeth is rotated towards a first end position. Thus, the first end teeth meshes with the toothed rack 11 of the connector housing. The at least one cam follower 110 (as best seen in FIG. 8C) of the electrical counter-connector 100 is located in the top left position of the cam slots 34. The mate-assist slider 30 is on the very left end of the connector housing 10 in the open position of the lever 20 (unmating connection) (FIG. 4). The gear 22 is rotated towards a second end position. Thus, the second end teeth meshes with the toothed rack 11 of the connector housing. The cam follower of the electrical counter-connector 100 is located in the bottom right position of the cam slots 34.

Notably, if the cam slots were inclined in the opposite direction, i.e., to the top right of this figure, the electrical connector arrangement 1 of FIG. 3A would correspond to the open position (unmating connection) and the electrical connector of FIG. 4 would correspond to the closed position (mating connection). It is also understood that the embodiment of this figure corresponds to an electrical connector assembly 200. The electrical connector assembly 200 may be an electrical connector arrangement 1 as described herein that includes an electrical counter-connector 100.

FIG. 4 shows a connector housing 10 of an electrical connector arrangement 1 in greater detail. FIG. 5 shows a mate-assist slider 30 of an electrical connector arrangement 1 in greater detail.

The toothed rack 11 of the connector housing 10 is arranged in a top portion of the connector housing 10, such that the teeth of the toothed rack 11 are pointing in the unmating direction (UD). In other words, the teeth of the toothed rack 11 are pointing to a bottom side of the connector housing 10. Thereby, upon rotation of the lever in a lever closing direction, the mate-assist slider 30 is moved in a first direction (FD), which corresponds to the right direction herein. Thereby, the electrical counter-connector 100 (not shown) is moved in the mating direction (MD). The flat guiding channel 12 includes an opening 13 in a substantially central position of the flat guiding channel 12, for facilitating that a gear 22 of the lever 20 can be received in the at least partially circular recess 32 (FIG. 5) after the mate-assist slider 30 is movably mounted in the flat guiding channel 12.

The mate-assist slider 30 does not include a toothed rack and/or a gear or any similar functional means. Furthermore, the connector housing 10 (without the mate-assist slider 30) and the cover 40 also do not include such functional means for accommodating a rotation of a part.

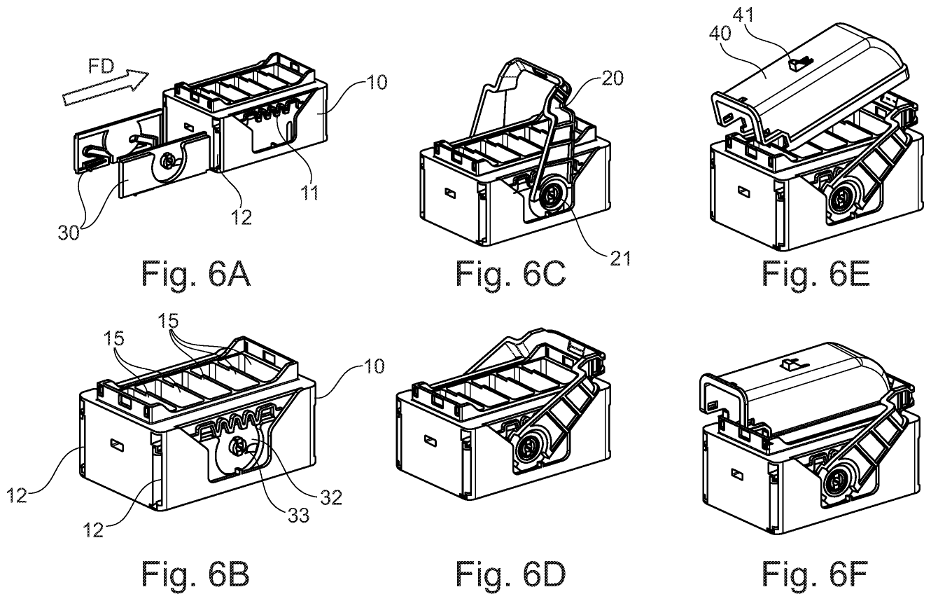

FIGS. 6A to 6F show an electrical connector arrangement according to an embodiment of the invention in different assembly steps.

In FIG. 6A the mate-assist sliders 30 are inserted into the flat guiding channel 12 of the connector housing 10. This is indicated as the first direction (FD). In FIG. 6B the mate-assist sliders 30 are positioned in such a manner that the lever 20 can be mounted (FIG. 6C). The opening 13 of the flat guiding channel 12 facilitates such mounting. In FIG. 6D the lever 20 is rotated clockwise to the opening position. In FIG. 6E the cover 40 is inserted to arrive at the assembled electrical connector arrangement 1 in FIG. 6F.

The cover 40 substantially closes the upper end of the electrical connector arrangement 1 and facilitates that cables (not shown) and/or connector modules (not shown) that are received in connector module slots 15 of the connector housing 10 are not damaged. The electrical connector arrangement 1 can be equipped with different connector modules that are inserted into the slots 15 of the connector housing 10. Thus, the electrical connector arrangement is modular and can be electrically configured as desired. The connector housing 10 includes five module slots 15 for five connector modules. The cover 40 can be hooked to the connector housing 10 by a positive locking fit at one side of the top end of the connector housing 10 (e.g., the left one in this figure) and by means of a latch at the other side of the top end of the connector housing 10 (e.g., the right one in this figure). The cover 40 could also be attached to the connector housing 10 if rotated 180° about an axis parallel to the mating/unmating direction.

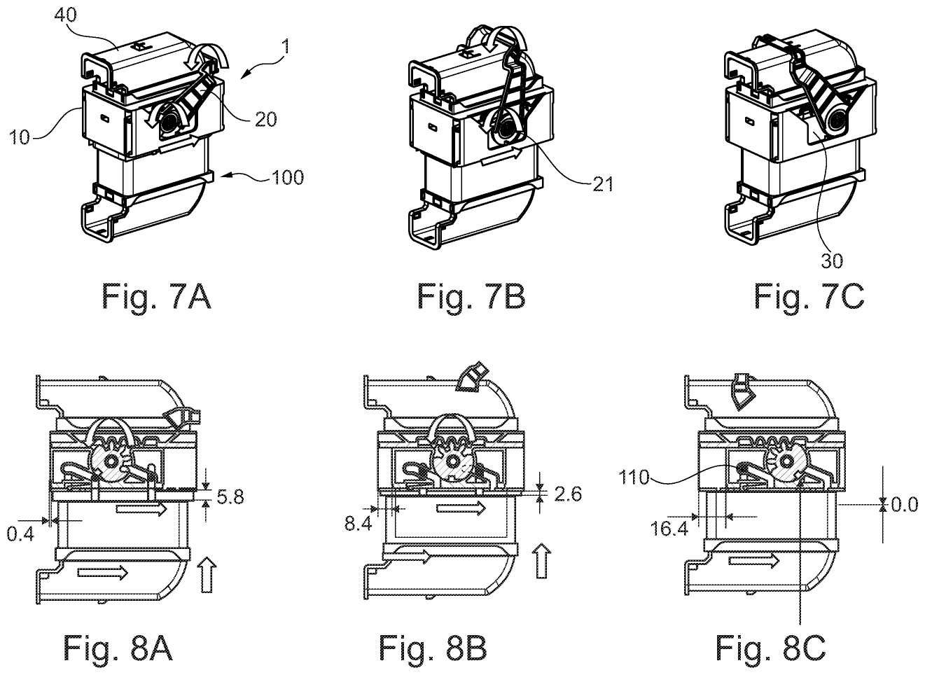

FIGS. 7A to 7C show an electrical connector arrangement 1 in a mating process with an electrical counter-connector 100. FIGS. 8A to 8C show the mating process of FIGS. 7A to 7C, where some parts are at least partially transparent.

In FIGS. 7A and 8A, the electrical connector arrangement 1 is in an unmating condition (lever 20 is in an open position). As can be seen the electrical counter-connector 100 extends further at the bottom of the connector housing 10 of the electrical connector arrangement 1, by an amount of about 5.8 mm. Furthermore, a distance of the mate-assist slider 30 to a left end of the connector housing 10 is about 0.4 mm. Then, the lever 20 is rotated from the open position counterclockwise to an intermediate position (FIGS. 7A, 8A). The electrical counter-connector 100 is thereby pulled towards the electrical connector arrangement 1 for mating such that the extension of the electrical counter-connector 100 is reduced from 5.8 mm to 2.6 mm. At the same time the pivot point 21 of the lever 20 is moved horizontally together with the mate-assist slider 30 by the same linear movement towards the right side in this figure. Thus, the distance of the mate-assist slider 30 to the left end of the connector housing 10 is increased from 0.4 mm to about 8.4 mm. In FIG. 7C and 8C the connectors are in the mated condition in which the lever 20 is latched at the cover 40 with the cover latch 41. Furthermore, the lever 20 is an oblique vertical position. The electrical counter-connector 100 is pulled fully towards the electrical connector arrangement 1 and the extension of the electrical counter-connector 100 is reduced from 2.6 mm to substantially 0 mm. The distance of the mate-assist slider 30 to a left end of the connector housing 10 is increased from 8.4 mm to about 16.4 mm. Thereby, a horizontal movement of the mate-assist slider 30 and of the pivot point 21 of the lever 21 of 16 mm causes a vertical movement of the electrical counter-connector 100 of 5.8 mm.

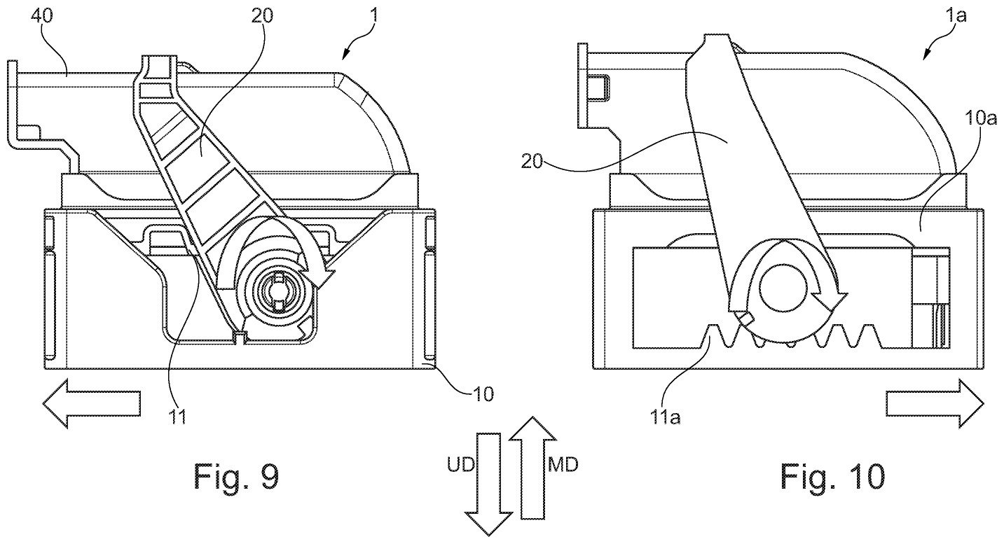

FIG. 9 shows an electrical connector arrangement 1 according to an embodiment of the invention with the teeth rack 11 arranged in a top portion of the connector housing 10. The lever 20 is in a closed position (mating connection). The teeth of the toothed rack 11 are pointing in the unmating direction (UD), thus the teeth of the toothed rack 11 are pointing to a bottom side of the connector housing 10. The gear 22 of the lever 20 meshes with the toothed rack 11 from the bottom to the top direction as seen from the gear 22. Rotation of the lever 20 in a lever opening direction (clockwise), causes the mate-assist slider 30 to be moved to the left.

FIG. 10 shows an electrical connector arrangement 1a according to an embodiment of the invention with the teeth rack 11a arranged in a bottom portion of the connector housing 10a. The teeth of the toothed rack 11a are pointing in the mating direction (MD), thus the teeth of the toothed rack 11a are pointing to a top side of the connector housing 10a. The gear 22 of the lever 20 meshes with the toothed rack 11a from the top to the bottom direction, seen from the gear 22. Rotation of the lever 20 in a lever opening direction (clockwise), causes the mate-assist slider 30 to be moved to the right.

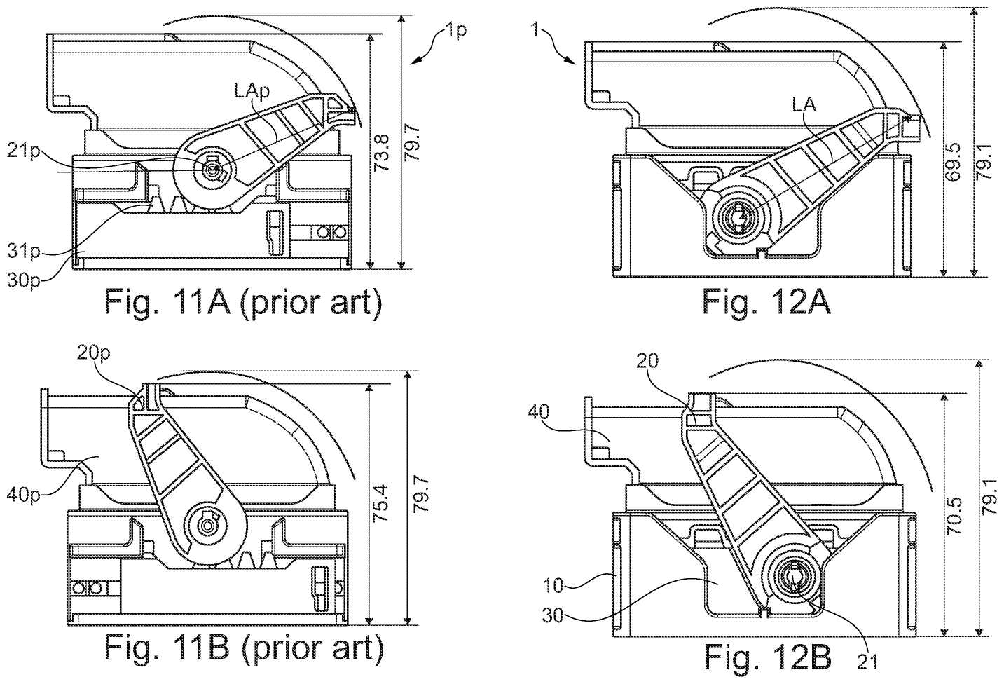

FIG. 11A to 11B show an electrical connector arrangement 1p in a mating process with an electrical counter-connector (not shown) according to the prior art. The lever 20p has a lever arm length LAp of less than 49 mm, e.g., 48.4 mm. Due to the rotation of the lever 20p, a maximum installation height of the electrical connector arrangement 1p of 79.7 mm is required. The maximum height of the electrical connector arrangement 1p is 73.8 mm. The ratio of the length LAp of the lever 20p and the maximum installation height of the electrical connector arrangement 1p is less than 61%. This is disadvantageous, as such a small length LAp of the lever 20p necessitates increased forces for mating. Indeed, an exemplary verification test of a worst-case scenario, i.e., a test with 15 HMTD contacts required a mating force of 77.1 N. HMTD contacts may be understood as high-speed modular twisted-pair data contacts, which may be used in automotive networking applications. Due to the relatively robust shielding, increased forces are required for making such contacts.

FIG. 12A to 12B show an electrical connector arrangement 1 according to an embodiment of the invention in a mating process with an electrical counter-connector (not shown). The lever 20 has a lever arm length LA of at least 57 mm, 59 mm or at least 60 mm, e.g., 61.1 mm. The maximum installation height of the electrical connector of 79.1 mm. The maximum height of the electrical connector arrangement 1 is 69.5 mm. The ratio of the length LA of the lever 20 and the maximum installation height of the electrical connector arrangement 1 is at least 75%, e.g., at least 77.2%. The same test as conducted as with the prior art shows mating forces of 70.1 N. Thus, forces for mating can be reduced.

The terms “opened position”, “open position”, “unmating connection”, “un-mating connection”, “unmated connection”, “un-mated connection” are used herein to describe that the mate-assist lever and/or the mate-assist slider is/are in such an arrangement that the electrical connector is in a mating connection, i.e., it is mated with an electrical counter-connector. The terms “closed position”, “close position”, “mating connection” are used herein to describe that the mate-assist lever and/or the mate-assist slider is/are in such an arrangement that the electrical connector is in an unmating connection, i.e., it is not mated with an electrical counter-connector. The lever being in a “closed position” is used herein to describe that the lever is rotated in such a manner that a mating connection can be established. The terms “pivot point”, “rotation point”, “point of rotation” are used herein to describe the point about which the mate-assist lever can be rotated. The term “installation height” of the electrical connector arrangement as used herein refers to the height required such that a mating, e.g., installation, can be performed. Thereby, the installation height may include an extension of the lever, i.e., an extension beyond the connector housing and/or cover during rotation of the lever. The height may be measured substantially parallel to the mating and/or unmating direction. The term “maximum height” of the electrical connector arrangement as used herein refers to the maximum height of the electrical connector without an extension of the lever. Therefore, the maximum height is the height of the connector housing and the cover. The height is measured substantially parallel to the mating and/or unmating direction.

In some aspects, the techniques described herein relate to an electrical connector arrangement, including a connector housing, and a mate-assist lever being rotatable about a pivot point and configured to facilitate, upon rotation, mating and unmating with a corresponding electrical counter-connector; wherein the pivot point is configured to move relative to the connector housing upon rotation of the lever.

In some aspects, the techniques described herein relate to an electrical connector arrangement, further including a mate-assist slider configured to be mounted linearly movable on the connector housing.

In some aspects, the techniques described herein relate to an electrical connector arrangement, wherein the mate-assist lever is pivotably mountable on the mate-assist slider.

In some aspects, the techniques described herein relate to an electrical connector arrangement, wherein the mate-assist slider, when mounted, is configured to be moved from a first position corresponding to an unmated condition of the connectors to a second position, corresponding to a mated condition.

In some aspects, the techniques described herein relate to an electrical connector arrangement, wherein the mate-assist lever and the mate-assist slider are configured such that a rotation of the mate-assist lever causes a linear movement of the mate-assist slider relative to the connector housing.

In some aspects, the techniques described herein relate to an electrical connector arrangement, wherein a movement direction of the mate-assist slider is substantially perpendicular to a mating and unmating direction.

In some aspects, the techniques described herein relate to an electrical connector arrangement, wherein the mate-assist slider does not include any functional toothed rack, a gear, and/or a pinion.

In some aspects, the techniques described herein relate to an electrical connector arrangement, wherein the connector housing includes a flat guiding channel, formed by at least one outer wall of the connector housing, wherein the guiding channel is configured to receive the mate-assist slider, such that the mate-assist slider is configured to be at least partially enclosed by the connector housing.

In some aspects, the techniques described herein relate to an electrical connector arrangement, wherein the flat guiding channel includes an opening in a substantially central position of the guiding channel and two side pockets on opposing ends of the guiding channel, the side pockets formed by an outer wall of the connector housing, wherein the opening facilitates receiving the mate-assist lever after the mate-assist slider is received in the guiding channel.

In some aspects, the techniques described herein relate to an electrical connector arrangement, wherein the mate-assist slider has an at least partially circular recess and a circular sleeve in a center of the recess extending perpendicular from the recess for rotatably receiving the pivot point of the mate-assist lever.

In some aspects, the techniques described herein relate to an electrical connector arrangement, wherein the mate-assist slider includes at least one cam slot configured to engage with at least one cam follower of the electrical counter-connector, such that a linear movement of the mate-assist slider causes a relative movement of the connectors in mating respectively unmating direction.

In some aspects, the techniques described herein relate to an electrical connector arrangement, wherein the connector housing includes a toothed rack and wherein the mate-assist lever includes a gear with one or more teeth, configured to mesh with the toothed rack upon rotation of the mate-assist lever.

In some aspects, the techniques described herein relate to an electrical connector arrangement, wherein the toothed rack is arranged in a top portion of the connector housing, such that the teeth of the toothed rack are pointing in an unmating direction.

In some aspects, the techniques described herein relate to an electrical connector arrangement, including a mate-assist slider; and an electrical counter-connector including at least one cam follower, wherein the mate-assist slider is mounted linearly movable on the connector housing and includes at least one cam slot configured to engage with the at least one cam follower, wherein the connector housing includes a toothed rack, wherein the mate-assist lever is pivotably mounted on the mate-assist slider and includes a gear with one or more teeth configured to mesh with the toothed rack upon rotation of the mate-assist lever, and wherein, upon rotation of the mate-assist lever, a linear movement of the mate-assist slider is caused, which causes a relative movement of the connectors in mating respectively unmating direction.

In some aspects, the techniques described herein relate to an electrical connector arrangement, including a cover configured to be mounted on a top side of the connector housing, opposite to a bottom side at which the electrical counter-connector is configured to be received, wherein the cover includes a cover latch that is configured to latch with the mate-assist lever, when the mate-assist lever is in a closed position corresponding to a mated condition with the electrical counter-connector.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. An electrical connector arrangement, comprising:
a connector housing, and
a mate-assist lever being rotatable about a pivot point and configured to facilitate, upon rotation, mating and unmating with a corresponding electrical counter-connector;
wherein the pivot point is configured to move relative to the connector housing upon rotation of the mate-assist lever.

2. The electrical connector arrangement according to claim 1, further comprising a mate-assist slider configured to be mounted linearly movable on the connector housing.

3. The electrical connector arrangement according to claim 2, wherein the mate-assist lever is pivotably mountable on the mate-assist slider.

4. The electrical connector arrangement according to claim 2, wherein the mate-assist slider, when mounted, is configured to be moved from a first position corresponding to an unmated condition to a second position, corresponding to a mated condition.

5. The electrical connector arrangement according to claim 2, wherein the mate-assist lever and the mate-assist slider are configured such that a rotation of the mate-assist lever causes a linear movement of the mate-assist slider relative to the connector housing.

6. The electrical connector arrangement according to claim 2, wherein a movement direction of the mate-assist slider is substantially perpendicular to a mating and unmating direction.

7. The electrical connector arrangement according to claim 2, wherein the mate-assist slider does not comprise any functional toothed rack, a gear, and/or a pinion.

8. The electrical connector arrangement according to claim 2, wherein the connector housing comprises a flat guiding channel, formed by at least one outer wall of the connector housing, wherein the guiding channel is configured to receive the mate-assist slider, such that the mate-assist slider is configured to be at least partially enclosed by the connector housing.

9. The electrical connector arrangement according to claim 8, wherein the flat guiding channel comprises an opening in a substantially central position of the guiding channel and two side pockets on opposing ends of the guiding channel, the two side pockets formed by an outer wall of the connector housing, wherein the opening facilitates receiving the mate-assist lever after the mate-assist slider is received in the guiding channel.

10. The electrical connector arrangement according to claim 2, wherein the mate-assist slider has an at least partially circular recess and a circular sleeve in a center of the recess extending perpendicular from the recess for rotatably receiving the pivot point of the mate-assist lever.

11. The electrical connector arrangement according to claim 2, wherein the mate-assist slider comprises at least one cam slot configured to engage with at least one cam follower of the electrical counter-connector, such that a linear movement of the mate-assist slider causes a relative movement of the electrical connector arrangement and the electrical counter-connector in mating respectively unmating direction.

12. The electrical connector arrangement according to claim 1, wherein the connector housing comprises a toothed rack and wherein the mate-assist lever comprises a gear with one or more teeth, configured to mesh with the toothed rack upon rotation of the mate-assist lever.

13. The electrical connector arrangement according to claim 12, wherein the toothed rack is arranged in a top portion of the connector housing, such that teeth of the toothed rack are pointing in an unmating direction.

14. The electrical connector arrangement according to claim 1, comprising:
a mate-assist slider; and
an electrical counter-connector comprising at least one cam follower,
wherein the mate-assist slider is mounted linearly movable on the connector housing and comprises at least one cam slot configured to engage with the at least one cam follower,
wherein the connector housing comprises a toothed rack,
wherein the mate-assist lever is pivotably mounted on the mate-assist slider and comprises a gear with one or more teeth configured to mesh with the toothed rack upon rotation of the mate-assist lever, and
wherein, upon rotation of the mate-assist lever, a linear movement of the mate-assist slider is caused, which causes a relative movement of the electrical connector arrangement and the electrical counter-connector in mating respectively unmating direction.

15. The electrical connector arrangement according to claim 1, comprising:
a cover configured to be mounted on a top side of the connector housing, opposite to a bottom side at which the electrical counter-connector is configured to be received, wherein the cover comprises a cover latch that is configured to latch with the mate-assist lever, when the mate-assist lever is in a closed position corresponding to a mated condition with the electrical counter-connector.
